(19) United States
(12) Patent Application Publication
(10) Pub. No.: US 2004/0060450 A1
(43) Pub. Date: Apr. 1, 2004

(54) Container

(75) Inventors: Michael Paul Gividen, Earls Barton (GB); Rebecca Julia Lewis, Wymington (GB); Laurence John Smith, Crawley (GB)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/664,383

(22) Filed: Sep. 17, 2003

(30) Foreign Application Priority Data
Sep. 17, 2002 (GB) 0221566.3
Feb. 7, 2003 (GB) 0302883.4

(51) Int. Cl. A23F 3/00

(52) U.S. Cl. 99/279

(57) ABSTRACT

Infused liquid beverages are made from infusion bags (for example tea bags) having a string and tag attached in a container comprising a receptacle for holding the infusing liquid, a lid for the receptacle provided with an opening having a first portion which is capable of gripping the string of the infusion bag and a second portion through which the string of the infusion bag can move into and out of the container.

The present invention relates to containers in which infused liquid beverages are dispensed. Many liquid beverages are made by infusion. These include tea beverages which may be made by infusing green, black or oolong teas derived from the plant Camellia sinensis or by infusing other plant materials to give the so-called herbal teas and coffee beverages which are made by infusing roasted and ground coffee beans or by infusing processed coffee products such as instant coffee powders or granules. The preferred liquid beverages are tea beverages.

Liquid beverages such as those sold to the consumer in an out-of-home environment (eg fast food or take-away establishments or catering situations such as canteens in the workplace) are often served in a container which has a lid to minimise spillage. The lid may be provided with a dispensing outlet through which the consumer drinks the beverage. Such beverages are often prepared by immersing an infusion bag (for example a tea bag) in water in the container and allowing the contents of the infusion bag to infuse for sufficient time to achieve the strength of beverage required by the consumer. In this specification the term “infusion bag” is intended to mean a porous bag which contains an infusible material from which a liquid beverage is made by infusion. To enhance the infusion many consumers agitate the infusion bag in the water. If the infusion bag is provided with a string and tag, the user may use the string to move the infusion bag up and down through the water in the container. After a sufficient infusion time the user must remove the infusion bag from contact with the water to prevent further infusion. This can be a messy operation as the infusion bag when removed from the water still has water contained in it which can drip as the infusion bag is moved. The above-described agitation and removal of the infusion bag is made much more difficult if the container is provided with a lid which must be removed before the agitation and bag removal can take place. Removing the lid, and optionally replacing it before the beverage is consumed increases the risk that the beverage will be spilled. As the beverage may be hot this increases the chance of the consumer being hurt by the hot liquid and of the liquid being spilled onto the consumer's clothing or into the surroundings.

A first aspect of the present invention provides a container for serving liquid infused beverages made from infusion bags having a string and tag attached, said container comprising a receptacle for holding liquid, a lid for the receptacle provided with an opening having a first portion which is capable of gripping the string of the infusion bag and a second portion through which the string of the infusion bag can move into and out of the container.

A second aspect of the present invention provides a lid for a container for serving infused liquid beverages made from infusion bags having a string and tag attached, said lid being provided with an opening having a first portion which is capable of gripping the string of the infusion bag and a second portion through which the string of the infusion bag can move into and out of the container.

Preferably the lid is also provided with a dispensing outlet through which the consumer drinks the beverage.

The first portion of the opening may be in the form of a slit cut into the lid in such a way that the opposed sides of the slit grip the string of the infusion bag. The second portion of the opening may be an aperture located at one end of the first portion or anywhere along the length of the first portion. The aperture may be of any shape (for example circular, elliptical, triangular, square, polygonal eg hexagonal) provided that the aperture is of sufficient size that the string of the infusion bag can move easily through it. If the second portion of the opening is circular in cross-section, its diameter should be greater than the diameter of the string on the infusion bag. If the first portion is in the form of a slit, the length of the slit is preferably sufficient so that the tag attached to the string can be pushed through the slit without bending the tag. To facilitate the passage of the tag through the first portion, one or more further slits may extend away from the first portion, preferably at right angles to it. The further slits may extend from either side of the first portion or only from one side. In a preferred embodiment further slits extend at right angles from the first portion on both sides of the first portion, said further slits being aligned with the second portion of the opening.

The invention will now be illustrated by the following description of embodiments thereof, given by way of example only. The description is directed to infusion bags containing tea (tea bags) but it should be understood that the invention also has utility for the preparation of other infused liquid beverages such as coffee. The description has reference to the accompanying drawings in which:

FIG. 1 is a cross-sectional view of a lid for a container in which a tea beverage is to be dispensed;

FIG. 2 is a plan view of the lid of FIG. 1;

FIGS. 3 to 5 are diagrammatic cross-sectional views illustrating steps in the making of a tea beverage; and

FIG. 6 is plan view of a second embodiment of a lid.

A lid 1 has a circular lip 2 which engages with the open end of a receptacle (not shown in FIGS. 1 and 2) to fix the lid to the receptacle. The lid has a domed central section 3 provided with a dispensing outlet 4 through which a tea beverage contained in the receptacle can be consumed. Lids having these features are known and are commercially available from several suppliers. According to the present invention the lid 1 is provided with an opening generally shown as 5 in FIG. 2. The opening 5 comprises a slit 6 forming the first portion of the opening 5 and a circular aperture 7 having a diameter greater than the diameter of the string on a tea bag to be used to make a tea beverage. The length of the slit 6 is sufficient that a tag on the string of the tea bag to be used can pass through the slit 6 without the need to fold the tag.

The slit 6 is preferably formed by making a single cut with a sharp blade. No material is removed from the lid in such a cutting operation. The sides of the slit 6 will then abut and can grip the string of the tea bag. Alternatively the slit 6 may be formed by removing material from the lid to provide a slit in which the sides of the slit are spaced apart. The width of the slit must however be less than the diameter of the string on a tea bag so that the sides of the slit can grip the string.

The aperture 7 is shown as circular in FIG. 2 but it can be of any shape that allows the string of the tea bag to move freely through the aperture. In the embodiment shown in FIG. 2 the aperture 7 is shown at the midpoint of the slit 6. The aperture 7 can however be located anywhere along the length of the slit 6.

FIGS. 3 to 5 illustrate stages in the preparation of a tea beverage. FIG. 3 shows a receptacle 8 containing water 9 and a tea bag 10. The tea bag 10 has a string 11 having a tag 12 attached to the end remote from the tea bag 10. The receptacle 8 is closed by a lid 1. The string 11 passes through the aperture 7 in the opening 5 on the lid 1.

The second embodiment shown in plan view in FIG. 6 shares many features with the embodiment shown in FIGS. 1 and 2. The same reference numerals are used in respect of these shared features. The second embodiment has further slits 14 extending at right angles from the slit 6 on both sides of the slit 6. The further slits 14 are aligned with the aperture 7.

Before a tea beverage can be made the components shown in FIG. 3 must be assembled. The receptacle 8, the lid 1 and the tea bag 10 will probably be supplied separately. Tag 12 of the tea bag 10 is pushed through the slit 6 from the side which will be the inside of the lid with the string 11 passing through the aperture 7. The receptacle 8 is then filled with water. If the tea beverage is to be drunk hot, the temperature of the water is preferably at least 85° C., more preferably greater than 90° C. If the tea bag 10 is intended to provide a cold tea beverage (also known as iced tea) the temperature of the water is preferably less than 10° C. more preferably around 5° C. The tea bag 10 is then placed in the water 9 and the lid 1 is put on the receptacle 8. The tea bag 10 will either float in the water or will drop to the bottom of the receptacle 8. The consumer can move the tea bag up and down in the water by alternatively pulling and releasing the string 11. As the string can move freely through the aperture 7 the tea bag 10 will be moved upwards in the water as the string 11 is pulled through the lid 1 and will sink down in the water under the force of gravity when the string 11 is released. This movement is illustrated by the double headed arrow 14 in FIG. 4. When the desired infusion period has passed the user pulls the string 11 until the tea bag is withdrawn from the water and is located adjacent the inner side of the lid 1 (as shown in FIG. 5). The string 11 is then pulled into the slit by exerting sideways pulling movement on the string. The string is gripped by the sides of the slit 6 and the tea bag cannot move back into the water. The infusion then stops and the consumer can drink the tea beverage through the dispensing outlet 4.

If the consumer consumes the tea beverage without added milk or sweetener, the movement of the tea bag and its removal into the lid can occur without the need to remove the lid from the receptacle with the attendant risk of scalding if the tea beverage is hot or the accidental spillage of the tea beverage. If any required milk or sweetener are placed in the receptacle before the lid is placed on the receptacle then the consumer can drink the tea beverage in the way he or she wants to without the need to remove the lid.

The present invention ensures that the consumer can be supplied with an infused liquid beverage in a safe and convenient manner and avoids the need to remove and dispose of the infusion bag before consuming the beverage.

1. A container for serving infused liquid beverages made from infusion bags having a string and tag attached, said container comprising a receptacle for holding liquid, a lid for the receptacle provided with an opening having a first portion which is capable of gripping the string of the infusion bag and a second portion through which the string of the infusion bag can move into and out of the container.

2. A container as claimed in claim 1 wherein the first portion of the opening is in the form of a slit cut into the lid.

3. A container as claimed in claim 2 wherein the second portion of the opening is an aperture located on the slit.

4. A container as claimed in claim 3 wherein the aperture is circular and has a diameter greater than that of the string on the infusion bag

5. A container as claimed in claim 2 wherein the length of the slit is sufficient that the tag attached to the string may be pushed through it without bending the tag.

6. A container as claimed in claim 1 wherein the lid has a dispensing outlet.

7. A container as claimed claim 1 wherein the lid has one or more further slits extending away from the first portion,

8. A container as claimed in claim 7 wherein the further slit or slits extend at right angles to the first portion

9. A container as claimed in claim 7 wherein the further slit or slits are aligned with the second portion of the opening.

10. A lid for a container for serving infused liquid beverages made from infusion bags having a string and tag attached, said lid being provided with an opening having a first portion which is capable of gripping the string of the infusion bag and a second portion through which the string of the infusion bag can move into and out of the container.

11. A lid as claimed in claim 10 wherein the first portion of the opening is in the form of a slit cut into the lid.

12. A lid as claimed in claim 11 wherein the second portion of the opening is an aperture located on the slit.

13. A lid as claimed in claim 12 wherein the aperture is circular and has a diameter greater than that of the string on the infusion bag

14. A lid as claimed in claim 10 wherein the length of the slit is sufficient that the tag attached to the string may be pushed through it without bending the tag.

15. A lid as claimed in claim 10 wherein the lid has one or more further slits extending away from the first portion,

16. A lid as claimed in claim 15 wherein the further slit or slits extend at right angles to the first portion

17. A lid as claimed in claim 16 wherein the further slit or slits are aligned with the second portion of the opening.

18. A lid as claimed in claim 10 wherein the lid has a dispensing outlet.
